(19) United States
(12) Patent Application Publication
(10) Pub. No.: US 2004/0174607 A1
(43) Pub. Date: Sep. 9, 2004

(54) Lens

(76) Inventors: Robert Brunner, Jena (DE); Knut Hage, Apolda (DE); Hans-Jurgen Dobschal, Kleinromstedt (DE); Klaus Rudolf, Jena (DE); Reinhard Steiner, Stadtroda (DE)

Correspondence Address: Douglas J Christensen, Patterson Thuente Skaar & Christensen, 4800 IDS Center, 80 South Eighth Street, Minneapolis, MN, 55402, US

(21) Appl. No.: 10/481,208

(22) PCT Filed: Jun. 19, 2002
(86) PCT No.: PCT/EP02/06798

(30) Foreign Application Priority Data
Jun. 22, 2001 (DE) 101302126

(51) Int. Cl. G02B 3/00

(52) U.S. Cl. 359/642

(57) ABSTRACT

In an objective (1), in particular a microscope objective, said objective comprising an object-side first optical group (5) with a positive refractive power, and a second optical group (6), arranged following the first optical group (5), with a negative refractive power, and said first optical group (5) including several refractive elements (7, 8, 9, 10), the first optical group (5) comprises at least one diffractive element (11) having a refraction-enhancing and achromatizing effect.

### OBJECTIVE

The invention relates to an objective, in particular to a microscope objective, said objective comprising an object-side first optical group with a positive refractive power, and a second optical group, arranged following the first optical group, with a negative refractive power, and said first optical group including several refractive elements.

Such a microscope objective is used, for example, in microscopes for optical control of masks used in the manufacture of semiconductor components. Such masks comprise, e.g., a quartz substrate on which the mask structure is formed by means of chromium. A removable plastic layer, whose surface facing away from the mask structure is at a distance of 7.5 mm from the mask structure, is applied thereon for protection of said mask. In order to achieve the resolution required for optical control, the microscope objective has a numerical aperture of greater than 0.5, in which case the working distance of the microscope objective, however, is then usually less than 1 mm. This has the effect that the protective layer needs to be removed for control of the mask, which, on the one hand, increases the expenditure of work during control and, on the other hand, involves the risk that particles which considerably reduce the quality of the mask may be undesirably applied to the mask.

Further, in such a microscope objective, at wavelengths of less than 266 nm, it is also required to provide fluorite lenses and quartz glass lenses for achromatization. However, fluorite is very expensive and also extremely difficult to process with the required precision and, moreover, also has disadvantageously hygroscopic properties.

In view thereof, it is an object of the present invention to improve an objective, in particular a microscope objective, of the aforementioned type such that it has a high numerical aperture and, at the same time, a great working distance.

In an objective of the aforementioned type, this object is achieved in that the first optical group contains at least one diffractive element which has a diffraction-enhancing and achromatizing effect.

The positive refractive power or positive effect (e.g. of the first optical group) is understood herein to be the property of reducing the divergence of a beam or transforming it into convergence, or of enhancing convergence. In connection with the first optical group, this applies to light of at least one order of diffraction of the diffractive element. Thus, for said light of the at least one order of diffraction, the diffractive element itself also has a positive refractive power and, consequently, a refraction-enhancing effect. The negative refractive power or negative effect (e.g. of the second optical group) is understood herein to be the property of increasing the divergence of a beam, or of reducing the convergence of a beam, or also of transforming said convergence into divergence. Therefore, the achromatizing effect of the diffractive element exists for the at least one order of diffraction for which the diffractive element also has a refraction-enhancing effect.

With the diffractive element, the objective according to the invention comprises an optical element by means of which the spherical aberration and coma of the objective according to the invention may be advantageously improved, for example, and which, at the same time, also contributes to the achromatization of the objective, because the dispersion of the diffractive element is countercurrent to the dispersion of the refractive elements of the objective according to the invention.

Thus, in the objective according to the invention, there is no need to use fluorite lenses for achromatization in applications in the UV range (wavelengths of less than 300 nm), which simplifies its manufacture in comparison with a conventional objective, which also comprises fluorite lenses due to the required achromatization.

In particular, the materials for the optical elements in the objective according to the invention may be selected independently of the required achromatization with a view to other important properties (e.g. workability or transmission properties), wherein all of said optical elements may be made of the same or also of different materials.

Further, the diffractive element has a relatively high positive refractive power (or a strong positive effect) as compared with a refractive element, so that the number of elements of the objective according to the invention is clearly reduced as compared with an objective constituted exclusively of refractive elements. This is a particular advantage, especially in high performance objectives which are achromatized for a wavelength range of a few nanometers or less, because, due to the extremely high precision with which the optical elements have to be manufactured and adjusted, any element saved leads to an objective which is clearly more economical and faster to produce.

Moreover, a much shorter face-to-face dimension of the objective according to the invention as compared with the conventional (purely refractive) objective is advantageously realizable with the same aperture and the same working distance, allowing the objective according to the invention to be easily realized as an exchangeable objective, which may be inserted into already existing devices, such as optical inspection systems and microscopes, without having to change these devices for this purpose. This allows said devices to be easily re-fitted, without any problem, with the objective according to the invention, which has a very high numerical aperture and, at the same time, a very great working distance.

The diffractive element may preferably be designed such that, in addition to its achromatizing effect for the objective and its refraction-enhancing effect for the first optical group, spherical aberrations of a higher order caused by the remaining optical elements of the objective according to the invention are also compensated.

Further, the diffractive element, which is responsible for the achromatizing effect in the objective according to the invention, allows to prevent the problems of excessively small edge thicknesses and excessively small air gaps between the lenses, which occur in an objective consisting exclusively of refractive elements, due to the required achromatization, which makes the mounting technology unduly more complicated, so that, advantageously, the mounting of the optical elements is clearly simplified in the objective according to the invention. This is another reason why manufacture of the objective according to the invention is economical and fast.

In a preferred embodiment of the objective according to the invention, all optical elements of both optical groups are formed of a maximum of two different materials, preferably of the same material. Since achromatization is caused by the diffractive element, materials may be selected which are best suited for the spectral range in which the objective according to the invention is to be employed. For example, the material having the best transmission properties and/or the material which is the easiest to work may be selected. Thus, said elements may consist, for example, of quartz and/or calcium fluoride.

For a wavelength range of 193 nm±0.5 nm, 213 nm±0.5 nm, 248±0.5 nm and 266 nm±0.5 nm, suprasil (synthetic quartz) is preferred, and at 157 nm±0.5 nm, fluorite is the preferred material.

In particular, the objective according to the invention is designed such that the desired achromatization of the objective for a given wavelength range is effected completely by the at least one diffractive element. If the desired achromatization is the complete achromatization of the objective, optical arrangements arranged following the objective, such as a tube lens in a microscope, may be designed completely independently of the objective in terms of their achromatizing properties. Alternatively, the desired achromatization may be an incomplete achromatization of the objective according to the invention, so that the beam exiting the objective is not completely achromatized. The missing contribution to complete achromatization may then be provided, if desired, by an optical arrangement (e.g. a tube lens in a microscope) arranged following the objective.

What is essential in the objective according to the invention is that the achromatization of the refractive elements (which are preferably not achromatized themselves at all) of the objective according to the invention is substantially or even exclusively caused by the at least one diffractive element (or also by several diffractive elements). The second optical group preferably does not contain a diffractive element, but only one, or even several, refractive elements. Of course, the second optical group may also contain one or more diffractive elements.

In the objective according to the invention, the optical elements of both optical groups are preferably mounted without cement, thus advantageously avoiding the disadvantage of aging cement, which occurs in systems using optical cement, as is the case, in particular, at wavelengths in the UV range, where this represents a great problem. This ensures a very long useful life of the objective according to the invention.

In the objective according to the invention, the maximum beam diameter in the first optical group is advantageously greater than the maximum beam diameter in the second optical group. This allows a high numerical aperture and a short face-to-face dimension of the objective according to the invention to be realized, so that, in particular, using the objective according to the invention in a microscope, a high resolution may be achieved.

The diffractive element of the objective according to the invention is preferably a grating having rotation symmetry about the optical axis of the objective, so that incorporation and adjustment of the diffractive element in the objective according to the invention is simplified due to said symmetry. This also enables quick manufacture of the objective according to the invention.

An advantageous embodiment of the objective consists in that the diffractive element comprises a transmissive grating, preferably a phase grating, whose grating frequency increases radially outwardly from the optical axis of the objective. Said grating may be formed, for example, by annular depressions, which are concentric to the optical axis, said grating being preferably formed on a planar surface. This planar surface may be either a surface of a plane-parallel plate or also of a lens of the first optical group. Providing said grating on a planar surface simplifies its manufacture.

Alternatively, the grating may also be formed on a curved effective surface or interface of one of the diffractive elements of the first optical group. In this case, the number of optical elements is advantageously reduced again, so that manufacture of the objective according to the invention can be effected more rapidly and more economically.

It is further advantageous, in the objective according to the invention, to arrange the diffractive element in the area of the largest beam diameter in the first optical group, because this is where the high refractive power of the diffractive element may be put to its most effective use. Also, scattered light (light of undesired orders) is largely cut off by the mounts of the lenses arranged following the diffractive element or exits the objective with an intercept distance clearly differing from that of the useful light (which is used for imaging), so that the scattered light is very strongly expanded and, thus, leads to a very slight deterioration in imaging at the most.

Particularly advantageously, the grating is provided as a blaze grating, so that the light-collecting efficiency of the grating for a desired order of diffraction is extremely high. Light of this order of diffraction is the useful light imaged by means of the optical elements of the objective according to the invention, which are arranged following the diffractive element, and supposed to exit the objective as an achromatized beam.

If the blaze grating is formed by means of the holographic standing wave method, the edges of the depressions are steady and need not be approximated by a step function, so that, advantageously, practically no diffuse scattered light appears which would deteriorate the imaging property of the objective.

In order to get as close as possible to the theoretically optimal diffraction efficiency, the depressions of the diffractive element of the objective according to the invention are formed such that the depth of the individual depressions decreases as the radial distance from the depression to the center increases.

However, the depressions may also be formed alternatively such that they all have the same depth. In this case, manufacture of the grating is simplified, and it may be formed, for example, by means of structuring methods known from semiconductor manufacture.

In a grating of constant depth, it is particularly preferred, if the optimum depth for the edge region of the diffractive element is selected as the depth which all depressions have, since the edge region contributes the most to light collection due to its larger surface area as compared to the central portion of the grating, and the outer portion contributes largely to the aperture and, consequently, determines the resolution of the objective the most. For the same reason, in the grating comprising depressions having different depths, the depressions are preferably also formed in the edge region having the optimal depth.

A particularly preferred embodiment of the objective according to the invention consists in that only the diffracted light of a predetermined order, preferably of the positive or negative first order, from the diffractive element is used as achromatized and refraction-enhanced light for imaging and that the diffracted light of other orders is scattered light or unsuitable light which should not be used.

In a further advantageous embodiment of the objective according to the invention, a circular central stop is provided on or near the diffractive element, which stop is concentrically arranged relative to the optical axis of the objective and whose diameter is preferably selected such that diffraction light of the zeroth order, which is not cut off by the mounts of the optical elements arranged following the diffractive element, is securely cut off. Thus, diffraction light of the zeroth order does not disadvantageously deteriorate the imaging property of the objective according to the invention. Said diameter may, in fact, also be selected to be as large as the beam diameter of the beam exiting the second optical group. This has the advantageous effect that definitely no diffraction light of the zeroth order will deteriorate imaging.

Furthermore, in a preferred embodiment of the objective according to the invention, all refractive elements of the first optical group may each have a positive refractive power. This makes it possible for the first optical group, as a whole, to have a very high positive refractive power at a large aperture, so that the resolution is very high.

Further, the second optical group may comprise only elements having a negative refractive power, allowing the second optical group to easily form the desired beam, which is supposed to exit the second optical group and is preferably a parallel beam.

The invention will be explained in more detail below, by way of example, with reference to the drawings, wherein:

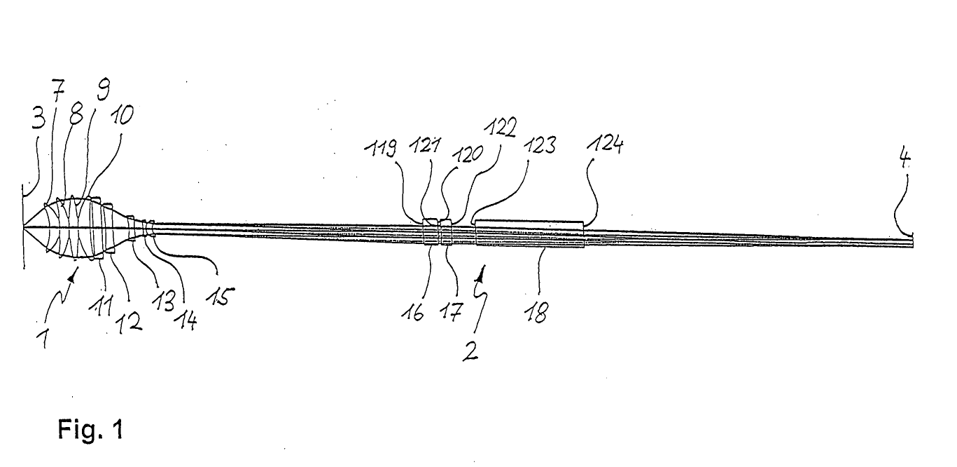

FIG. 1 shows a lens section of the optical structure of the microscope objective according to the invention, plus the tube lens unit;

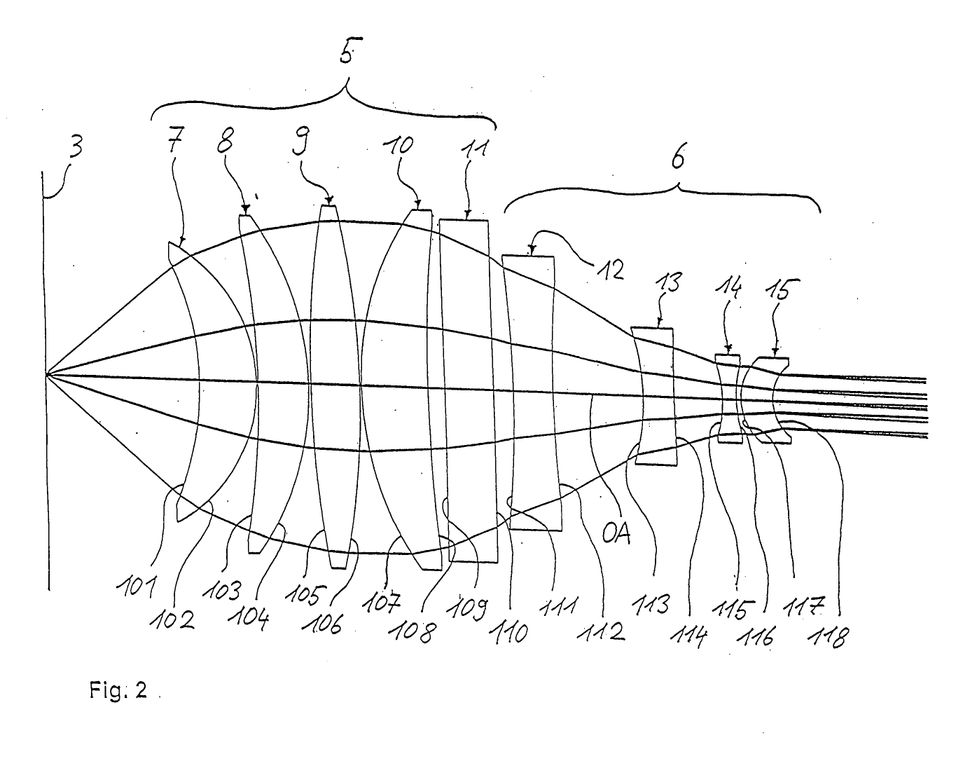

FIG. 2 shows an enlarged view of the microscope objective shown in FIG. 1;

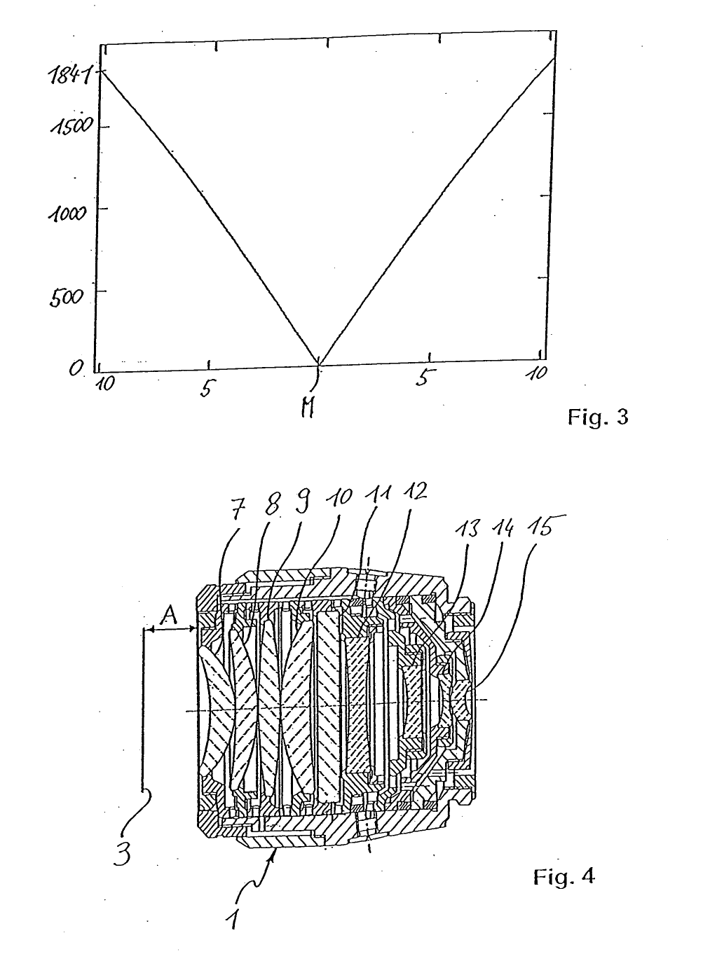

FIG. 3 shows a diagram indicating the grating frequency of the diffractive optical element;

FIG. 4 shows a cross-section of the microscope objective according to the invention, and

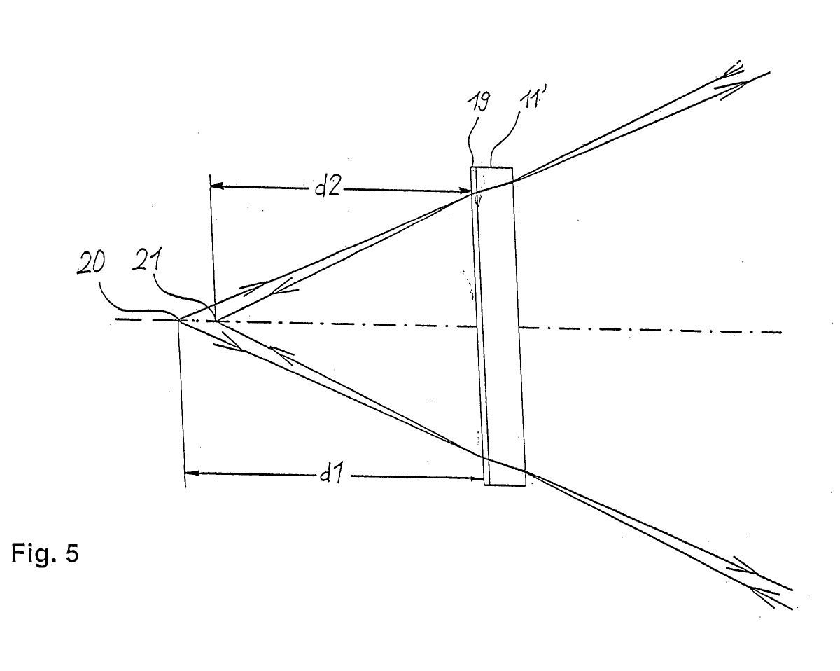

FIG. 5 shows a schematic view explaining the manufacture of the diffractive optical element.

As is evident from the lens section of the optical structure of a microscope shown in FIG. 1, a microscope objective 1 and a tube lens unit 2 arranged following it are provided so as to image an enlarged image of the object located in the object plane 3 into the image plane 4 (or intermediate image plane). The microscope objective 1 is a high-performance objective, which is employed in microscopes used, for example, in the control of masks for semiconductor manufacture. The microscope objective 1 described herein is achromatized for a spectral range of 193 nm+0.5 nm and has a magnification of 50 times at a numerical aperture of 0.65 and a working distance of 7.8 mm, the object field diameter being 0.1 mm and the image field diameter being 5.0 mm.

As is best seen from the enlarged representation in FIG. 2, the microscope objective 1 comprises an object-side first optical group 5 having a positive refractive power (or a positive effect) and a second optical group 6, arranged following the first optical group 5 and having a negative refractive power (or a negative effect), wherein all optical elements of both optical groups 5 and 6 are made of the same material, namely suprasil (synthetic quartz).

Viewed from left to right in FIG. 2, the first optical group 5 comprises first, second, third and fourth lenses 7, 8, 9 and 10, as well as a diffractive optical element 11. Fifth, sixth, seventh and eighth lenses 12, 13, 14 and 15 form the second optical group 6. The design of the lenses 7 to 10 and 12 to 15 and the arrangement of all optical elements 7 to 15 of the microscope objective 1 are evident from Table 1 below.

TABLE 1

| Surface to | Distance | | Radius | | |
|---|---|---|---|---|---|
| surface | [mm] | Surface | [mm] | | free diameter [mm] |
| 3-101 | 10.1 | 101 | 19.525 | concave | 14.9 |
| 101-102 | 3.7 | 102 | 10.442 | concave | 16.4 |
| 102-103 | 0.1 | 103 | 58.714 | concave | 19.3 |
| 103-104 | 3.3 | 104 | 19.248 | concave | 20.1 |
| 104-105 | 0.15 | 105 | 66.836 | convex | 21.5 |
| 105-106 | 3.2 | 106 | 57.874 | concave | 21.7 |
| 106-107 | 0.1 | 107 | 20.684 | convex | 21.5 |
| 107-108 | 4.3 | 108 | 97.407 | convex | 20.7 |
| 108-109 | 1.1 | 109 | planar | | 20.4 |
| 109-110 | 3.2 | 110 | planar | | 17.6 |
| 110-111 | 1.3 | 111 | 81.748 | concave | 16.1 |
| 111-112 | 2.6 | 112 | 73.387 | convex | 13.6 |
| 112-113 | 5.9 | 113 | 15.07 | concave | 7.6 |
| 113-114 | 2.0 | 114 | 81.748 | convex | 6.5 |
| 114-115 | 3.16 | 115 | 7.718 | concave | 4.8 |
| 115-116 | 0.9 | 116 | 8.292 | convex | 4.5 |
| 116-117 | 0.3 | 117 | 3.599 | convex | 4.6 |
| 117-118 | 2.06 | 118 | 2.973 | convex | 3.6 |

As shown in FIG. 1, the tube lens 2 comprises lenses 16, 17 and 18, whose structure and design are evident from the following Table.

TABLE 2

| Surface to surface | Distance [mm] | Surface | Radius [mm] | |
|---|---|---|---|---|
| 118-119 | 99.87 | 119 | 107.46 | convex |
| 119-120 | 5.7 | 120 | 42.17 | concave |
| 120-121 | 1.13 | 121 | 40.388 | concave |
| 121-122 | 3.8 | 122 | 281.84 | concave |

| | | | |
|---|---|---|---|
| 122-123 | 9.0 | 123 | planar |
| 123-124 | 40.04 | 124 | planar |
| 124- 4 | 120.65 | | |

The diffractive optical element 11 is a transmissive phase grating in which annular grooves, which are disposed concentrically relative to the optical axis OA of the objective 1, are formed in the surface 109 facing the object plane 3.

In this case, the diffractive optical element 11 is designed such that, on the one hand, it has a refraction-enhancing effect for the first optical group 5 (i.e. an increase in the positive effect or in the positive refractive power) and that, on the other hand, it causes complete achromatization in the given spectral range (193 nm±0.5 nm) of the objective 1, in which case the diffracted light of the positive first order is used as the useful light for imaging. The diffracted light of other orders is scattered light, which, if possible, should not contribute to said imaging so as not to deteriorate it.

The positive first order is the first order of diffraction in which a parallel beam (a beam parallel to the optical axis OA of the objective) is deflected toward the optical axis OA. On the other hand, the first order of diffraction in which a parallel beam is deflected away from the optical axis OA is referred to as the negative first order of diffraction.

The angle of deflection for the diffracted light of the positive first order is adjusted via the grating frequency of the diffractive optical element 11. In practice, the grating frequency may be calculated by optimization calculations on the basis of the following phase polynomial p(r)

$$p ( r ) = {\sum }_{i = 1}^{N} {a}_{i} {r}^{2 i}$$

wherein r is the radial distance from the center M of the phase grating and N is a positive integer greater than 1. For optimization, the coefficients aᵢ are changed. The phase polynomial p(r) indicates the phase shift as a function of the radial distance r and allows to calculate the grating frequency of the diffractive element on the basis of the derivation of the phase polynomial according to the radial distance r. In turn, said grating frequency then allows to determine the angle of emergence of each incident beam, so that the achromatized and refraction-enhancing effect of the grating may then be determined. In this optimizing calculation, other aberrations of the lenses 7 to 10 and 12 to 15 (such as higher spherical aberrations) may then be corrected as well, wherein a value of 3 to 10 is preferably selected for N.

FIG. 3 shows the course of the grating frequency in a central section of a diffractive optical element 11 optimized in this way. In doing so, the distance from the grating center M is plotted on the abscissa (one subdivision corresponds to 5 mm), and the number of lines (grooves) per mm is plotted on the ordinate, the zero point being located at the point of intersection between the ordinate and the abscissa and each subdivision of the ordinate corresponding to 500 lines per mm. Thus, FIG. 3 shows that, with a radially increasing distance from the center M, the grating frequency increases from 0 lines per mm (at the center M) to the maximum frequency of 1841 lines per mm.

A theoretically optimal diffraction efficiency may be achieved in such a grating if the depth of the individual depressions is selected such that it decreases with increasing radial distance of the depressions from the center, so that the depth of a depression in the edge region of the grating is smaller than the depth of a depression located further inwardly. Such a grating can be easily produced, in an advantageous manner, using the holographic standing-wave method described hereinafter, because in this method, the desired depth distribution is already generated as well. Alternatively, the grating may also be produced such that the grooves preferably all have the same depth, said depth being fixed at the optimal value (e.g. 300 nm) for the edge region of the optical diffractive element 11, because, due to its larger surface area as compared with the central middle region, the edge region contributes the most to light collection and, thus, also the most to the diffraction efficiency. Further, the edge region contributes the most to the resol the objective according to the invention. The grating with a constant groove depth and the rating with variable depth may be formed by means of structuring methods known from semiconductor manufacture, wherein a suitable lacquer coat, which is applied to a substrate in which the grating is to be formed, is exposed (e.g. by mask exposure or electron beam lithography) and tructured. The structure in the lacquer coat is then transferred to the substrate by means of known methods (such as reactive ion etching). This allows the desired grating to be formed with the required precision.

As mentioned above, the diffracted light of the positive first order is used for imaging, so that the diffraction light of the other orders represents undesired scattered light. In order to keep the influence of said scattered light on the imaging quality as small as possible, the diffractive optical element 11 in the first optical group 5 is arranged in the region of the largest beam diameter. Thus, a large part of the scattered light is cut off already by the mounts of the subsequent lenses 12 to 15, wherein the beam diameter is considerably smaller, as shown in FIG. 2. Further, the scattered light which is not cut off by the mounts of the optical elements 12 to 15 following the diffractive optical element 11 exits the microscope objective 1, due to the great number of lines of the diffractive optical element 11, with a clearly different intercept distance than that of the diffracted light of the positive first order, so that the scattered light, due to its converging or diverging expansion on the way to the intermediate image, which is located between the microscope objective 1 and the tube lens 2, is strongly expanded and, thus, cut off, as much as possible, by the mounts of the tube lens 2. The very small part which is not cut off by the tube lens 2 enters the image only in a strongly defocussed form, so that its extent does not lead to a marked deterioration of the image.

Further, the diffractive optical element 11 is designed such that it fully effects achromatization of the objective 1 in the predetermined spectral range, so that all elements 7 to 15 of the microscope objective 1 may consist of the same material without any problem. Thus, the material which is best suited for the desired wavelength, for example, which has the best transmission and/or is easiest to work, may be selected.

FIG. 4 shows a sectional view of the microscope objective 1 according to the invention, wherein the mounts of the optical elements 7 to 15 are also illustrated. As is immediately apparent from the illustration, while the microscope objective 1 has a very compact structure, free from cement, it has a very small number of optical elements (7 to 15), a large working distance A of 7.8 mm, at a numerical aperture of 0.65. Due to the very short face-to-face dimension of the microscope objective 1, it may be incorporated, particularly also in modular form, into already existing inspection systems.

The grating structure in the surface 109 of the diffractive optical element 11 may be generated holographically. For this purpose, a lacquer coat 19 is applied to an upper surface of a plane-parallel plate 11′ (suprasil), which is then exposed by means of the holographic standing-wave method, as schematically shown in FIG. 5. The lacquer coat 19 is designed for exposure at a wavelength of 458 nm and has a thickness of 200 to 500 nm.

In the holographic standing-wave method, two converging, coherent spherical waves (preferably laser radiation) are superimposed such that the interference pattern appearing in the lacquer coat 19 leads to exposure of the desired latent grating structure. In this case, the first spherical wave has its origin in the point 20 and is propagated to the right, as viewed in FIG. 5. The second spherical wave is propagated counter-currently to the first spherical wave and has its focus in the point 21. The distances d1, d2 from the points 20 and 21 to the lacquer coat 19 are selected such that the desired grating structure in the lacquer coat 19 is exposed. The distance d1 from the point 20 to the upper surface of the lacquer coat 19 is 22.776 mm, and the distance d2 from the point 21 to the upper surface of the lacquer coat 19 is 21.158 mm.

After exposure of the lacquer coat 19, the latter is developed, so that the lacquer coat 19 is structured and exhibits the desired grating structure. Said grating structure is then transferred to the surface of the plane-parallel plate 11′ by means of reactive ion-etching (RIE), so as to thereby achieve the desired depth of the depressions. Thereafter, any possibly still existing residues of the lacquer coat 19 are removed, so that the diffractive optical element 11 is finished.

A further improvement in the imaging property of the objective according to the invention may be achieved by applying a central stop (not shown) to the surface 109 or 110 of the diffractive optical element 11, said stop being circular in shape and arranged concentrically to the optical axis OA. The diameter of said central stop is preferably selected to be as large as the beam diameter of the beam exiting the second optical group 6. This has the effect that the diffraction light of the zeroth order is cut off from the central region around the optical axis OA and, consequently, does not enter the second optical group 6, which prevents a deterioration of the imaging property of the objective 1 by diffraction light of the zeroth order from the central region. The diffraction light of the zeroth order which is not caught by the stop, is cut off by the mounts of the lenses 12 to 15 arranged following the diffractive element 11, so that improved imaging properties are achieved by means of the stop.

1. An objective (1), in particular a microscope objective, said objective comprising a first optical group (5) with a positive refractive power, and a second optical group (6), arranged following the first optical group (5), with a negative refractive power, and said first optical group (5) including several refractive elements (7, 8, 9, 10), characterized in that the first optical group (5) comprises at least one diffractive element (11), which has a refraction-enhancing and achromatizing effect.

2. The objective (1) as claimed in claim 1, characterized in that the desired achromatization of the objective (1) for a given wavelength range is effected completely by the at least one diffractive element (11).

3. The objective (1) as claimed in claim 1 or 2, characterized in that all optical elements (7, 8, 9, 10, 11, 12, 13, 14, 15) of both optical groups (5, 6) consist of a maximum of two different materials, preferably of the same material.

4. The objective (1) as claimed in any one of claims 1 to 3, characterized in that all optical elements (7, 8, 9, 10, 11, 12, 13, 14, 15) of both optical groups (5, 6) are supported without cement.

5. The objective (1) as claimed in any one of claims 1 to 4, characterized in that the maximum beam diameter in the first optical group (5) is greater than the maximum beam diameter in the second optical group (6).

6. The objective (1) as claimed in any one of claims 1 to 5, characterized in that the diffractive element (11) is a grating having rotation symmetry about the optical axis (OA) of the objective (1).

7. The objective (1) as claimed in any one of claims 1 to 6, characterized in that the diffractive element (11) is a transmissive phase grating.

8. The objective (1) as claimed in claim 6 or 7, characterized in that the grating frequency of the grating increases radially outwardly from the optical axis (OA) of the objective (1).

9. The objective (1) as claimed in any one of claims 6 to 8, characterized in that the grating comprises annular depressions, which are oriented concentrically relative to the optical axis (OA) of the objective (1).

10. The objective (1) as claimed in claim 9, characterized in that all depressions have the same depth.

11. The objective (1) as claimed in claim 9, characterized in that the depth of the individual depressions decreases as the radial distance from the optical axis (OA) of the objective increases.

12. The objective (1) as claimed in any one of claims 6 to 11, characterized in that the grating is formed on one side of a plane-parallel plate.

13. The objective (1) as claimed in any one of claims 6 to 11, characterized in that the grating is formed on an optically effective surface of one of the refractive elements (7, 8, 9, 10) of the first optical group (5).

14. The objective (1) as claimed in any one of claims 6 to 13, characterized in that the grating is a blaze grating.

15. The objective (1) as claimed in any one of claims 1 to 14, characterized in that the at least one diffractive element (11) is arranged in the region of the first optical group (5) having the largest beam diameter.

16. The objective (1) as claimed in any one of claims 1 to 15, characterized in that the diffracted light of a predetermined order, preferably of the positive or negative first order, of the diffractive element (11) is used for imaging.

17. The objective (1) as claimed in any one of claims 1 to 16, characterized in that the diffractive element (11) comprises a circular stop, which is arranged concentrically to the optical axis (OA) of the objective (1) and whose diameter is preferably selected such that it is at least as large as the beam diameter of the beam exiting the second optical group (6).

18. The objective (1) as claimed in any one of claims 1 to 17, characterized in that its numerical aperture is greater than 0.5 and its working distance (A) is greater than 6 mm.

19. The objective (1) as claimed in any one of claims 1 to 18, characterized in that all refractive elements (7, 8, 9, 10) of the first optical group (5) each have a positive refractive power.

20. The objective (1) as claimed in any one of claims 1 to 19, characterized in that the second optical group (6) only comprises elements having a negative refractive power.
